(19) United States
(12) Patent Application Publication
(10) Pub. No.: US 2007/0274388 A1
(43) Pub. Date: Nov. 29, 2007

(54) Method and apparatus for encoding/decoding FGS layers using weighting factor

(75) Inventors: Tammy Lee, Seoul (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/701,392

(22) Filed: Feb. 2, 2007

Related U.S. Application Data
(60) Provisional application No. 60/789,583, filed on Apr. 6, 2006.

(30) Foreign Application Priority Data
Jul. 24, 2006 (KR) 10-2006-0069355

(51) Int. Cl. H04B 1/66

(52) U.S. Cl. 375/240.13; 375/E07.09; 375/E07.255

(57) ABSTRACT

Provided is a method of encoding FGS layers by using weighted average sums. Method includes calculating a first weighted average sum by using a restored block of n^{th} enhanced layer of a previous frame and a restored block of a base layer of a current frame; calculating a second weighted average sum by using a restored block of n^{th} enhanced layer of a next frame and a restored block of a base layer of the current frame; generating a prediction signal of n^{th} enhanced layer of the current frame by adding residual data of (n−1)^{th} enhanced layer of the current frame to a sum of the first weighted average sum and the second weighted average sum; and encoding residual data of n^{th} enhanced layer, which is obtained by subtracting the generated prediction signal of n^{th} enhanced layer from the restored block of n^{th} enhanced layer of the current frame.

### CROSS-REFERENCE TO RELATED APPLICATION

This application and claims priority from Korean Patent Application No. 10-2006-0069355 filed on Jul. 24, 2006, in the Korean Intellectual Property Office, and U.S. Provisional Patent Application No. 60/789,583 filed on Apr. 6, 2006 in the United States Patent and Trademark Office, the disclosures of which are entirely incorporated herein by reference.

### BACKGROUND OF THE INVENTION

1. Field of the Invention

Methods and apparatuses consistent with the present invention relate to video compression technology. More particularly, the present invention relates to a method and apparatus for encoding/decoding Fine Granular Scalability (FGS) layers by using weighted average sums in a coding technology of FGS layers using an adaptive reference scheme.

2. Description of the Prior Art

According to developments in information communication technologies including the Internet, multimedia services capable of supporting various types of information, such as text, image, music, etc., are increasing. Multimedia data usually have a large volume which requires a large capacity medium for storage of the data and a wide bandwidth for transmission of the data. Therefore, it is indispensable to use a compression coding scheme in order to transmit multimedia data including text, image, and audio data.

The basic principle of data compression lies in a process of removing redundancy in data. Data compression can be achieved by removing the spatial redundancy such as repetition of the same color or entity in an image, the temporal redundancy such as repetition of the same sound in audio data or nearly no change between temporally adjacent pictures in a moving image stream, or the perceptional redundancy based on the fact that the human visual and perceptional capability is insensitive to high frequencies. Data compression can be classified into loss/lossless compression according to whether the source data are lost or not, in-frame/inter-frame compression according to whether the compression is independent to each frame, and symmetric/non-symmetric compression according to whether time necessary for the compression and restoration is the same. In the typical video coding schemes, the temporal repetition is removed by temporal filtering based on motion compensation and the spatial repetition is removed by spatial transform.

Transmission media, which are necessary in order to transmit multimedia data generated after redundancies in the data are removed, show various levels of performance. Currently used transmission media include media having various transmission speeds, from an ultra high-speed communication network capable of transmitting several tens of mega bit data per second to a mobile communication network having a transmission speed of 384 kbps. In such an environment, it can be said that the scalable video coding scheme, that is, a scheme for transmitting the multimedia data at a proper data rate according to the transmission environment or in order to support transmission media of various speeds, is more proper for the multimedia environment.

In a broad sense, the scalable video coding includes a spatial scalability for controlling a resolution of a video, a Signal-to-Noise Ratio (SNR) scalability for controlling a screen quality of a video, a temporal scalability for controlling a frame rate, and combinations thereof.

Standardization of the scalable video coding as described above has been already progressed in Moving Picture Experts Group-21 (MPEG-4) part 10. In the work to set the standardization of the scalable video coding, there have been various efforts to implement scalability on a multi-layer basis. For example, the scalability may be based on multiple layers including a base layer, a first enhanced layer (enhanced layer 1), a second enhanced layer (enhanced layer 2), etc., which have different resolutions (QCIF, CIF, 2CIR, etc.) or different frame rates.

As is in the coding with a single layer, it is necessary to obtain a Motion Vector (MV) for removing the temporal redundancy for each layer in the coding with multi-layers. The motion vector includes a motion vector (former), which is individually obtained and used for each layer, and a motion vector (latter), which is obtained for one layer and is then also used for other layers (either as it is or after up/down sampling).

FIG. 1 is a view illustrating a scalable video codec using a multi-layer structure. First, a base layer is defined to have a frame rate of Quarter Common Intermediate Format (QCIF)-15 Hz, a first enhanced layer is defined to have a frame rate of Common Intermediate Format (CIF)-30 Hz, and a second enhanced layer is defined to have a frame rate of Standard Definition (SD)-60 Hz. If a CIF 0.5 Mbps stream is required, it is possible to cut and transmit the bit stream so that the bit rate is changed to 0.5 Mbps in CIF_{—}30 Hz_{—}0.7 Mbps of the first enhanced layer. In this way, the spatial, temporal, and SNR scalability can be implemented.

As noted from FIG. 1, it is possible to presume that the frames 10, 20, and 30 of respective layers having the same temporal position have similar images. Therefore, there is a known scheme in which a texture of a current layer is predicted from a texture of a lower layer either directly or through up-sampling, and a difference between the predicted value and the texture of the current layer is encoded. In “Scalable Video Model 3.0 of ISO/IEC 21000-13 Scalable Video Coding (hereinafter, referred to as SVM 3.0),” the scheme as described above is defined as an “Intra_BL prediction.”

As described above, the SVM 3.0 employs not only the “inter-prediction” and the “directional intra-prediction,” which are used for prediction of blocks or macro-blocks constituting a current frame in the conventional H.264, but also the scheme of predicting a current block by using a correlation between a current block and a lower layer block corresponding to the current block. This prediction scheme is called “Intra_BL prediction,” and an encoding mode using this prediction is called “Intra_BL mode.”

FIG. 2 is a schematic view for illustrating the three prediction schemes described above, which include an intra-prediction (\textcircled{1}) for a certain macro-block 14 of a current frame 11, an inter-prediction (\textcircled{2}) using a macro-block 15 of a frame 12 located at a position temporally different from that of the current frame 11, and an intra_BL prediction (\textcircled{3}) using texture data for an area 16 of a base layer frame 13 corresponding to the macro-block 14. In the scalable video coding standard as described above, one advantageous scheme is selected and used from among the three prediction schemes for each macro-block.

FIG. 3 is a block diagram illustrating the concept of a conventional coding of an FGS layer according to an adaptive reference scheme. In the current H.264 SE (Scalable Extension), FGS layers of frames are encoded by using an adaptive reference scheme. Referring to FIG. 3, it is assumed that FGS layers of P frames of closed loops include a base layer, a first enhanced layer, and a second enhanced layer. Then, the FGS layers are coded by using temporal prediction signals generated by adaptively referring to both a reference frame of the base layer and a reference frame of the enhanced layer.

More specifically, in order to encode a frame 62 of the second enhanced layer existing in the current frame t, it is necessary to obtain a temporal prediction signal P₂^{t} by calculating a weighted average of a frame 60 including reconstructed blocks of the base layer at the current frame t and a frame 50 including reference blocks of the second enhanced layer existing in the previous frame t−1 and then adding residual data R₁^{t} to the weighted average.
P₂^{t}=α×D₂^{t-1}+(1−α)×D₀^{t}+R₁^{t} (1)

In Equation (1), α denotes a predetermined weight known as a leaky factor, D₀^{t} denotes a restored block of the base layer at the current frame t (that is, a block included in the frame 60), D₂^{t-1} denotes a restored block of the second enhanced layer at the previous frame t−1 (that is, a block included in the frame 50), and R₁^{t} denotes the residual data (generated from frame 61) of the first enhanced layer at the current frame t.

By subtracting the temporal prediction signal P₂^{t} obtained by using Equation (1) from the restored block D₂^{t} at the current frame t, it is possible to obtain residual data R₂^{t}=D₂^{t}−P₂^{t} of the second enhanced layer. Then, by quantizing and entropy-coding the calculated residual data R₂^{t}, it is possible to generate a bit stream. Meanwhile, the weight a can be derived by referring to a syntax factor of the slice header.

In Equation (1) showing the process of generating the prediction signal, it is possible to control drift due to partial decoding by referring to the reference frame of the base layer and is also possible to obtain a high coding efficiency by using the reference frame of the enhanced layer. However, there has been a need for a new technology for adaptively changing and using the leaky factor or the weight according to various characteristics of the block.

### SUMMARY OF THE INVENTION

Accordingly, an embodiment of the present invention has been made to solve the above-mentioned problems occurring in the prior art, and an object of the present invention is to provide a method and apparatus for encoding/decoding FGS layers by using weighted average sums, which can control drift and simultaneously improve the coding efficiency in coding of frames of all FGS layers.

Further to the above object, the present invention has additional technical objects not described above, which can be clearly understood by those skilled in the art from the following description.

According to an aspect of the present invention, there is provided a method of encoding FGS layers by using weighted average sums, the method including (a) calculating a first weighted average sum by using a restored block of an n^{th} enhanced layer of a previous frame and a restored block of a base layer of a current frame; (b) calculating a second weighted average sum by using a restored block of the n^{th} enhanced layer of a next frame and a restored block of a base layer of the current frame; (c) generating a prediction signal of the n^{th} enhanced layer of the current frame by adding residual data of an (n−1)^{th} enhanced layer of the current frame to a sum of the first weighted average sum and the second weighted average sum; and (d) encoding residual data of the n^{th} enhanced layer, which is obtained by subtracting the generated prediction signal of the n^{th} enhanced layer from the restored block of the n^{th} enhanced layer of the current frame.

According to another aspect of the present invention, there is provided a method of decoding FGS layers by using weighted average sums, the method including (a) calculating a first weighted average sum by using a restored block of an n^{th} enhanced layer of a previous frame and a restored block of a base layer of a current frame; (b) calculating a second weighted average sum by using a restored block of the n^{th} enhanced layer of a next frame and a restored block of a base layer of the current frame; (c) generating a prediction signal of the n^{th} enhanced layer of the current frame by adding residual data of an (n−1)^{th} enhanced layer of the current frame to a sum of the first weighted average sum and the second weighted average sum; and (d) generating a restored block of the n^{th} enhanced layer by adding the generated prediction signal of the n^{th} enhanced layer to residual data of the n^{th} enhanced layer.

According to still another aspect of the present invention, there is provided an encoder for encoding FGS layers by using weighted average sums, the encoder including a first weighted average sum calculator calculating a first weighted average sum by using a restored block of an n^{th} enhanced layer of a previous frame and a restored block of a base layer of a current frame; a second weighted average sum calculator calculating a second weighted average sum by using a restored block of the n^{th} enhanced layer of a next frame and a restored block of a base layer of the current frame; a prediction signal generator generating a prediction signal of the n^{th} enhanced layer of the current frame by adding residual data of an (n−1)^{th} enhanced layer of the current frame to a sum of the first weighted average sum and the second weighted average sum; and a residual data generator generating residual data of the n^{th} enhanced layer by subtracting the generated prediction signal of the n^{th} enhanced layer from the restored block of the n^{th} enhanced layer of the current frame.

According to yet another aspect of the present invention, there is provided a decoder for decoding FGS layers by using weighted average sums, the decoder including a first weighted average sum calculator calculating a first weighted average sum by using a restored block of an n^{th} enhanced layer of a previous frame and a restored block of a base layer of a current frame; a second weighted average sum calculator calculating a second weighted average sum by using a restored block of the n^{th} enhanced layer of a next frame and a restored block of a base layer of the current frame; a prediction signal generator generating a prediction signal of the n^{th} enhanced layer of the current frame by adding residual data of an (n−1)^{th} enhanced layer of the current frame to a sum of the first weighted average sum and the second weighted average sum; and an enhanced layer restorer generating a restored block of the n^{th} enhanced layer by adding the generated prediction signal of the n^{th} enhanced layer to residual data of the n^{th} enhanced layer.

Particulars of other embodiments are incorporated in the following description and attached drawings.

### BRIEF DESCRIPTION OF THE DRAWINGS

The above and other objects and features of the present invention will be more apparent from the following detailed description taken in conjunction with the accompanying drawings, in which:

FIG. 1 is a view illustrating a scalable video codec using a multi-layer structure;

FIG. 2 is a schematic view for illustrating three prediction schemes in a scalable video codec;

FIG. 3 is a block diagram illustrating the concept of a conventional coding of an FGS layer according to an adaptive reference scheme;

FIG. 4 is a flowchart illustrating the entire flow of a method of encoding FGS layers by using weighted average sums according to an exemplary embodiment of the present invention;

FIG. 5 is a flowchart illustrating the entire flow of a method of decoding FGS layers by using weighted average sums according to an exemplary embodiment of the present invention;

FIG. 6 illustrates the concept of an encoding of FGS layers by using weighted average sums according to an exemplary embodiment of the present invention;

FIG. 7 is a block diagram of an FGS encoder 100 for encoding FGS layers by using weighted average sums according to an exemplary embodiment of the present invention; and

FIG. 8 is a block diagram of an FGS decoder 200 for decoding FGS layers by using weighted average sums according to an exemplary embodiment of the present invention.

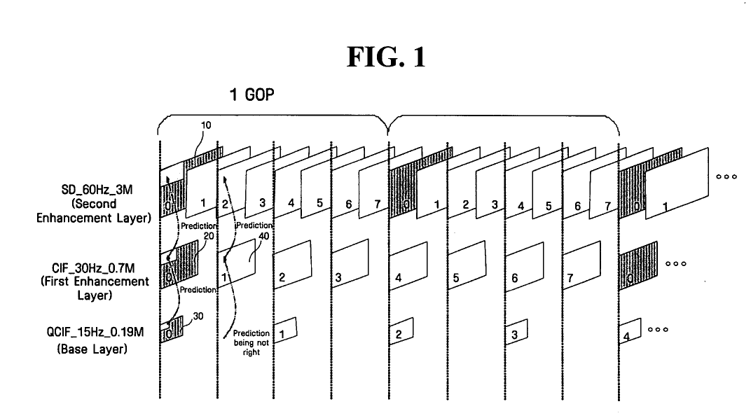

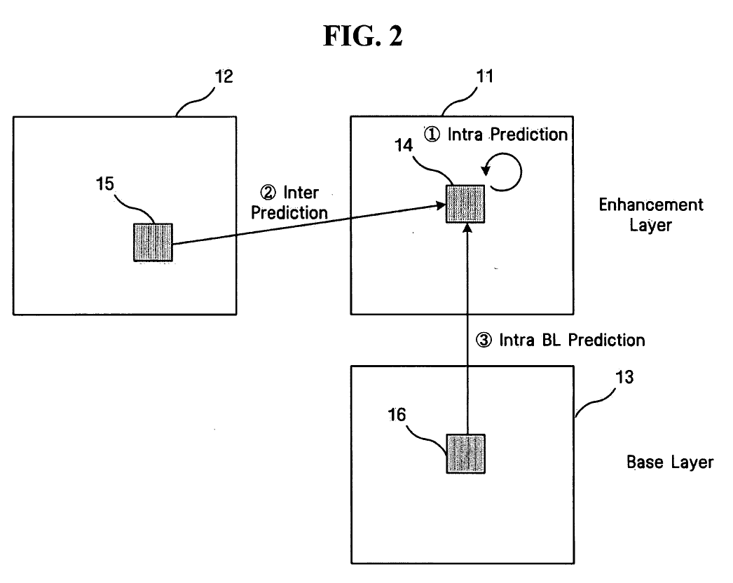

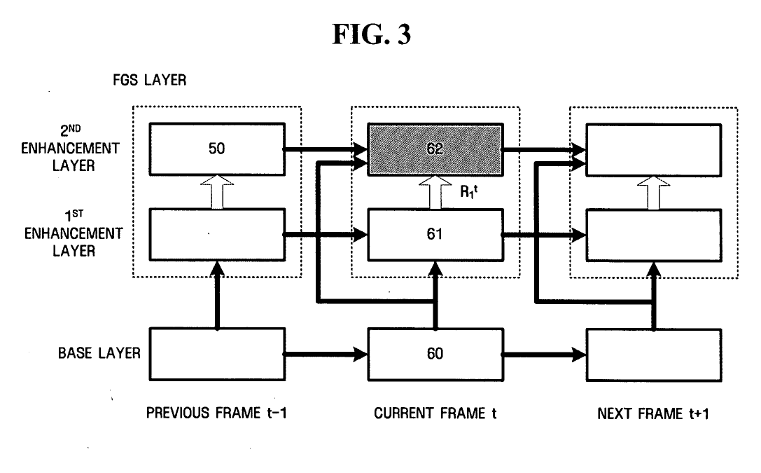

### DETAILED DESCRIPTION OF THE EXEMPLARY EMBODIMENTS

Advantages and features of the present invention, and ways to achieve them will be apparent from exemplary embodiments of the present invention as will be described below together with the accompanying drawings. However, the scope of the present invention is not limited to such exemplary embodiments, and the present invention may be realized in various forms. The exemplary embodiments to be described below are nothing but the ones provided to bring the disclosure of the present invention to perfection and assist those skilled in the art to completely understand the present invention. The present invention is defined only by the scope of the appended claims. Also, the same reference numerals are used to designate the same elements throughout the specification.

The present invention is described hereinafter with reference to block diagrams or flowcharts for illustrating apparatuses and methods for encoding/decoding FGS layers by using a predetermined weighted average sum according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, a base layer refers to a video sequence which has a frame rate lower than the maximum frame rate of a bit stream actually generated in a scalable video encoder and a resolution lower than the maximum resolution of the bit stream. In other words, the base layer has a predetermined frame rate and a predetermined solution, which are lower than the maximum frame rate and the maximum resolution, and the base layer need not have the lowest frame rate and the lowest resolution of the bit stream. Although the following description is given mainly for the macro-block, the scope of the present invention is not limited to the macro-block but can be applied to slice, frame, etc. as well as the macro-block.

Further, the FGS layers may exist between the base layer and the enhanced layer. Further, when there are two or more enhanced layers, the FGS layers may exist between a lower layer and an upper layer. As used herein, a current layer in order to obtain a prediction signal refers to the n^{th} enhanced layer, and a layer one step lower than the n^{th} enhanced layer refers to the (n−1)^{th} enhanced layer. Although the base layer is used as an example of the lower layer, it is just one embodiment and does not limit the present invention.

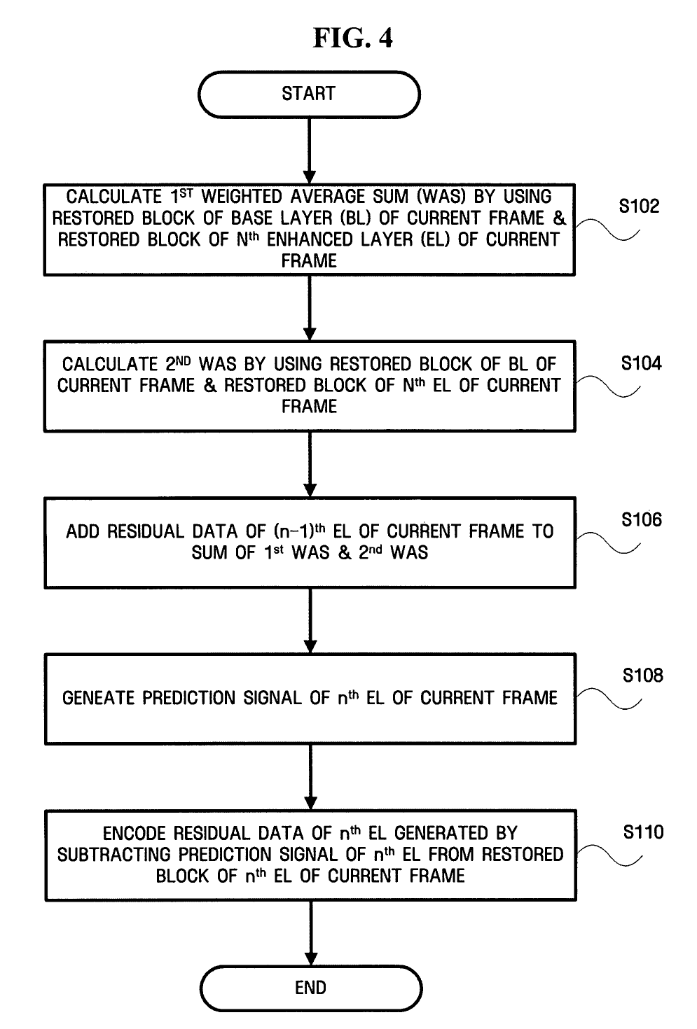

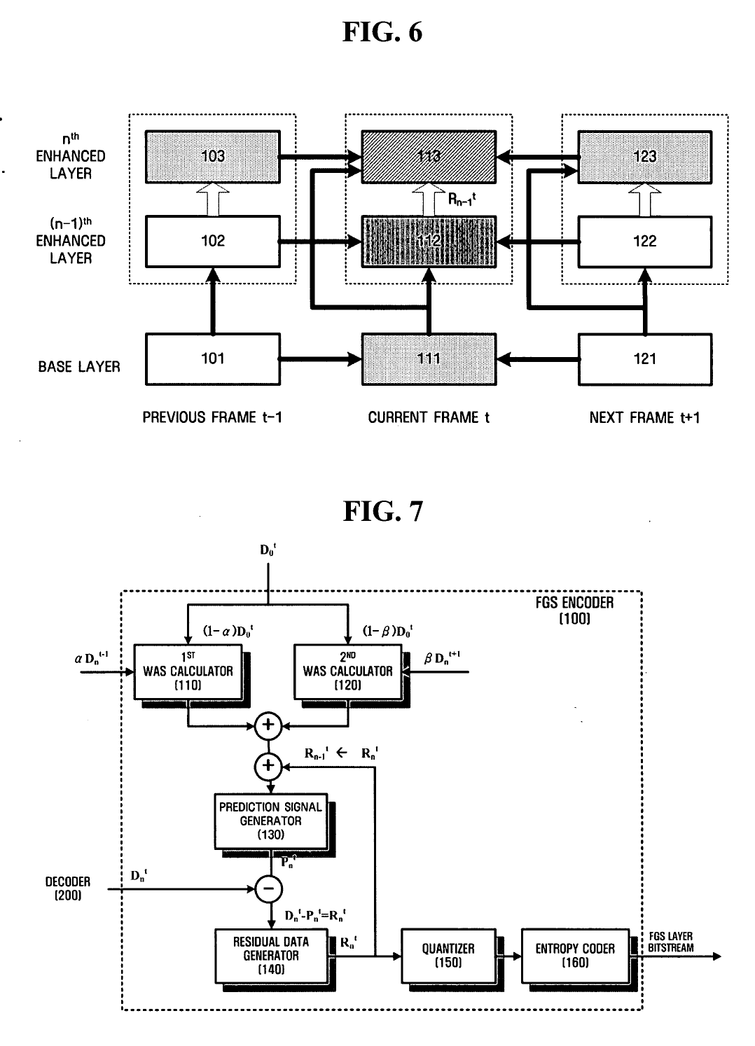

FIG. 4 is a flowchart illustrating the entire flow of a method of encoding FGS layers by using weighted average sums according to an embodiment of the present invention. The method shown in FIG. 4 will be described hereinafter with reference to FIG. 6 which illustrates the concept of an encoding of FGS layers by using weighted average sums according to an embodiment of the present invention.

First, a first weighted average sum is calculated by using a restored block 111 of the base layer of the current frame t and a restored block 103 of the n^{th} enhanced layer of the previous frame t−1(operation S102). The first weighted average sum can be obtained by Equation (2) below.
α×Dₙ^{t-1}+(1−α)×D₀^{t} (2)

In Equation (2), α denotes a predetermined first weight or leaky factor, D₀^{t} denotes the restored block 111 of the base layer of the current frame t, and Dₙ^{t-1} denotes the restored block 103 of the n^{th} enhanced layer of the previous frame t−1.

After obtaining the first weighted average sum by using Equation (2), it is necessary to calculate the second weighted average sum. To this end, the second weighted average sum is calculated by using a restored block 111 of the base layer of the current frame t and a restored block 123 of the n^{th} enhanced layer of the next frame t+1 (operation S102). The first weighted average sum can be obtained by Equation (3) below.
β×Dₙ^{t+1}(1−β)×D₀^{t} (3)

In Equation (3), β denotes a predetermined second weight or leaky factor, D₀^{t} denotes the restored block 111 of the base layer of the current frame t, and Dₙ^{t+1} denotes the restored block 123 of the n^{th} enhanced layer of the next frame t+1.

After obtaining the second weighted average sum by using Equation (3), the first weighted average sum and the second weighted average sum are added, so as to reflect both of the two weighted average sums. At this time, it is preferred, but not necessary, to calculate an arithmetic mean of the two average sums rather than to simply add the first weighted average sum and the second weighted average sum. Then, residual data of the (n−1)^{th} enhanced layer of the current frame t must be added to the arithmetic mean of the first weighted average sum and the second weighted average sum (operation S106). Then, a prediction signal of the n^{th} enhanced layer of the current frame t is generated (operation S108). The obtained prediction signal can be defined by Equation (4) below.

$${P}_{n}^{t } = \frac{\{ α \times {D}_{n}^{t - 1} + ( 1 - α ) \times {D}_{0}^{t} \} + \{ β \times {D}_{n}^{t + 1} + ( 1 - β ) \times {D}_{0}^{t} \}}{2} + {R}_{n - 1}^{t} \qquad ( 4 )$$

In Equation (4), Pₙ^{t} denotes the prediction signal of the n^{th} enhanced layer of the current frame t, and Rₙ₋₁^{t} denotes the residual data of the (n−1)^{th} enhanced layer of the current frame t (the residual data is generated from the frame 112).

Finally, residual data Rₙ^{t} of the n^{th} enhanced layer is obtained by subtracting the generated prediction signal Pₙ^{t} of the n^{th} enhanced layer of the current frame t from the restored block Dₙ^{t} of the n^{th} enhanced layer of the current frame t(Rₙ^{t}=Dₙ^{t}−Pₙ^{t}), and is then encoded (operation S110).

Meanwhile, the block 112 of the (n−1)^{th} enhanced layer of the current frame t in FIG. 6 generates a prediction signal by referring to the block 102 of the previous frame t−1, the block 122 of the next frame t+1, and the block 111 of the base layer, and the block 11 of the base layer of the current frame t generates a prediction signal by referring to blocks 101 and 121 of the previous frame and the next frame.

It is noted from Equation (4) that two weights or leaky factors α and β are used during the process of obtaining the prediction signal of the n^{th} enhanced layer. The first and second weights can be derived from syntax factors existing in the header of the slice including macro-blocks to be coded, and adaptively change from 0 to 1 depending on characteristic information of the macro-blocks of the n^{th} enhanced layer of the current frame t.

The characteristic information includes, for example, information about prediction direction of the macro-block, information about a Coded Block Pattern (CBP) value, and information about a Motion Vector Difference (MVD) value for the macro-block.

First, how the weights change according to the information about the prediction direction of the macro-block will be discussed hereinafter. When the prediction direction for partitions of the macro-block (or sub macro-block partitions) to be coded is bi-directional, the ratio of referring to the frames 103 and 123 of the n^{th} enhanced layer increases, while the ratio of referring to the frame 111 of the base layer decreases. Therefore, in Equation (4), the first weight and the second weight increase when the prediction direction is bi-directional, while the first weight and the second weight decrease when the prediction direction is uni-directional or in an intra-prediction mode.

Second, how the weights change according to the information about a CBP value will be discussed hereinafter. It is presumed that it is determined from the CBP value that there are a small number of included non-zero transform coefficients. At this time, in the inter-mode in which frames located at temporally different positions are referred, the ratio of reference between frames will increase. Therefore, the ratio of referring to the frames 103 and 123 of the n^{th} enhanced layer increases, while the ratio of referring to the frame 111 of the base layer decreases. As a result, in Equation (4), the first weight and the second weight increase in the inter-prediction mode, while the first weight and the second weight decrease in the intra-prediction mode.

Third, how the weights change according to the information about an MVD value for the macro-block will be discussed hereinafter. When the MVD has a small value, the ratio of reference between frames will increase. Therefore, the ratio of referring to the frames 103 and 123 of the n^{th} enhanced layer increases, while the ratio of referring to the frame 111 of the base layer decreases. As a result, in Equation (4), the first weight and the second weight increase as the MVD value decreases, while the first weight and the second weight decrease as the MVD value increases.

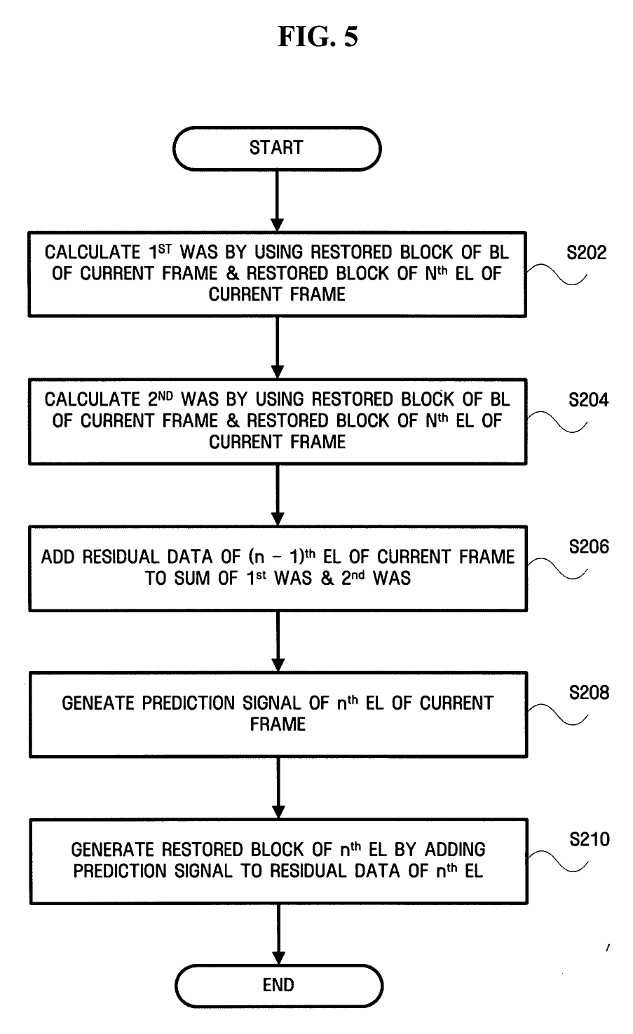

Hereinafter, a method of decoding FGS layers by using weighted average sums according to an embodiment of the present invention will be described with reference to FIGS. 5 and 6.

First, the first weighted average sum is calculated by using the restored block 111 of the base layer of the current frame t and the restored block 103 of the n^{th} enhanced layer of the previous frame t−1(operation S202). Then, the second weighted average sum is calculated by using the restored block 111 of the base layer of the current frame t and the restored block 123 of the n^{th} enhanced layer of the next frame t+1 (operation S204). Then, the first weighted average sum and the second weighted average sum are added and are then divided by 2, and the residual data of the (n−1)^{th} enhanced layer of the current frame is added to the quotient of the division (operation S206), so that a prediction signal of the n^{th} enhanced layer of the current frame (operation S208). Operations S202 to S208 are similar to operations S102 to S108 described above in the encoding process shown in FIG. 4, so more detailed description thereof will be omitted here.

When the prediction signal Pₙ^{t} of the n^{th} enhanced layer has been generated through operations S202 to S208, the generated prediction signal Pₙ^{t} of the n^{th} enhanced layer is added to the residual data Rₙ^{t} of the n^{th} enhanced layer, thereby producing the restored block Dₙ^{t} of the n^{th} enhanced layer (Dₙ^{t}=Pₙ^{t}+Rₙ^{t}) (operation 210). The residual data Rₙ^{t} of the n^{th} enhanced layer corresponds to residual data generated as a result of decoding and de-quantization of the FGS layer bit stream generated during the encoding process.

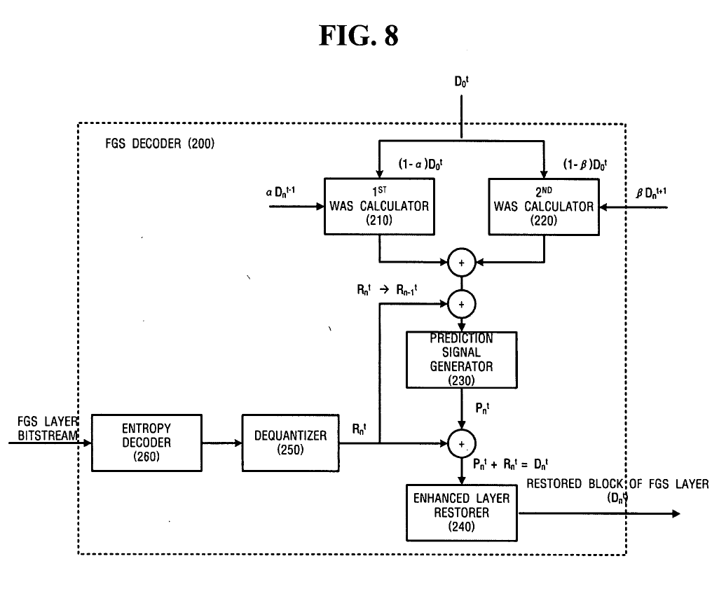

Hereinafter, an encoder and a decoder for performing the encoding and decoding will be described with reference to FIGS. 7 and 8.

From among the elements of the invention shown in FIGS. 7 and 8, the “unit” or “module” refers to a software element or a hardware element, such as a Field Programmable Gate Array (FPGA) or an Application Specific Integrated Circuit (ASIC), which performs a predetermined function. However, the unit or module does not always have a meaning limited to software or hardware. The module may be constructed either to be stored in an addressable storage medium or to execute one or more processors. Therefore, the module includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the modules may be either combined into a smaller number of elements or modules or divided into a larger number of elements or modules.

FIG. 7 is a block diagram of an FGS encoder 100 for encoding FGS layers by using weighted average sums according to an embodiment of the present invention.

A first weighted average sum calculator 110 calculates the first weighted average sum (α×Dₙ^{t-1}+(1−α)×D₀^{t}) by adding a product obtained by multiplying the restored block data of the n^{th} enhanced layer of the previous frame by the first weight α and a product obtained by multiplying of the restored block data of the base layer of the current frame by a value 1−α.

Similarly, a second weighted average sum calculator 120 calculates the second weighted average sum (β×Dₙ^{t+1}+(1−β)×D₀^{t}) by adding a product obtained by multiplying the restored block data of the n^{th} enhanced layer of the next frame by the second weight β and a product obtained by multiplying of the restored block data of the base layer of the current frame by a value 1−β.

A prediction signal generator 130 calculates an arithmetic mean of the first weighted average sum and the second weighted average sum by adding them and then dividing the sum of them by two, and then adds the residual data Rₙ₋₁^{t} of the (n−1)^{th} enhanced layer of the current frame to the arithmetic mean, thereby obtaining the prediction signal Rₙ^{t} of the n^{th} enhanced layer. For the residual data Rₙ₋₁^{t} of the (n−1)^{th} enhanced layer, the the residual data Rₙ^{t} of the n^{th} enhanced layer generated by the de-quantizer 250, thereby generating the data Dₙ^{t} of the restored block of the n^{th} enhanced layer. As a result, the enhanced layer restorer 240 generates the restored FGS layer data.

It is obvious to one skilled in the art that the scope of an apparatus for encoding/decoding FGS layers by using weighted average sums according to the present invention as described above includes a computer-readable recoding medium on which program codes for executing the above-mentioned method in a computer are recorded.

According to the present invention, it is possible to improve the coding efficiency and simultaneously control drift in the coding of frames for all FGS layers.

The effects of the present invention are not limited to the above-mentioned effects, and other effects not mentioned above can be clearly understood from the definitions in the claims by one skilled in the art.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the embodiments described above should be understood as illustrative not restrictive in all aspects. The present invention is defined only by the scope of the appended claims and must be construed as residual data Rₙ^{t} for the next frame generated by a residual data generator 140 is used.

Meanwhile, when data Dₙ^{t} of the block of the n^{th} enhanced layer of the current frame restored by the FGS decoder 200, which will be described later, has been input to the FGS encoder 100, the residual data generator 140 subtracts the prediction signal Pₙ^{t} of the n^{th} enhanced layer generated by the prediction signal generator 130 from the input data Dₙ^{t} of the restored block. As a result, the residual data Rₙ^{t} of the n^{th} enhanced layer are obtained, and the obtained residual data Rₙ^{t} are then input to either the prediction signal generator 130 as described above or a quantizer 150 which will be described below.

The quantizer 150 quantizes the residual data obtained by the residual data generator 140. The quantization refers to an operation of converting a Discrete Cosine Transform (DCT) coefficient expressed by a certain real value to discrete values with predetermined intervals according to a quantization table and then matching the converted discrete values with corresponding indexes. The value obtained by the quantization as described above is called “quantized coefficient.”

An entropy coder 160 generates an FGS layer bit stream through lossless coding of the quantized coefficient generated by the quantizer 150. The lossless coding schemes include various schemes, such as Huffman coding, arithmetic coding, variable length coding, etc.

FIG. 8 is a block diagram of a FGS decoder 200 for decoding FGS layers by using weighted average sums according to an embodiment of the present invention.

An entropy decoder 260 decodes an FGS layer bit stream in a video signal from the FGS encoder 100. The entropy decoder 260 extracts texture data through lossless coding of the FGS layer bit stream.

A de-quantizer 250 de-quantizes the texture data. The de-quantization corresponds to an inverse process of the quantization performed by the FGS encoder 100, in which values matching the indexes generated through the quantization process are restored from the indexes by using the quantization table used in the quantization process. By the de-quantization, the de-quantizer 250 generates the residual data Rₙ^{t} of the n^{th} enhanced layer.

Meanwhile, a first weighted average sum calculator 210, a second weighted average sum calculator 220, and a prediction signal generator 230 in the FGS decoder 200 have the same functions as those of the first weighted average sum calculator 110, the second weighted average sum calculator 120, and the prediction signal generator 130 of the FGS encoder 100 described above, so a detailed description of the first weighted average sum calculator 210, the second weighted average sum calculator 220, and the prediction signal generator 230 will be omitted here.

An enhanced layer restorer 240 adds the prediction signal Pₙ^{t} of the n^{th} enhanced layer generated by the prediction signal generator 230 to including the meaning and scope of the claims, and all changes and modifications derived from equivalent concepts of the claims.

What is claimed is:

1. A method of encoding Fine Granular Scalability (FGS) layers by using weighted average sums, the method comprising:
calculating a first weighted average sum by using a restored block of an n^{th} enhanced layer of a previous frame and a restored block of a base layer of a current frame;
calculating a second weighted average sum by using a restored block of an n^{th} enhanced layer of a next frame and the restored block of the base layer of the current frame;
generating a prediction signal of an n^{th} enhanced layer of the current frame by adding residual data of an (n−1)^{th} enhanced layer of the current frame to a sum of the first weighted average sum and the second weighted average sum; and
encoding residual data of the n^{th} enhanced layer, obtained by subtracting the generated prediction signal of the n^{th} enhanced layer from a restored block of the n^{th} enhanced layer of the current frame.

2. The method of claim 1, wherein the first weighted average sum is obtained by:
α×Dₙ^{t-1}+(1−α)×D₀^{t},
wherein α denotes a predetermined first weight, D₀^{t} denotes the restored block of the base layer of the current frame t, and Dₙ^{t-1} denotes the restored block of the n^{th} enhanced layer of the previous frame t−1.

3. The method of claim 1, wherein the second weighted average sum is obtained by:
β×Dₙ^{t+1}(1−β)×D₀^{t},
wherein β denotes a predetermined second weight, D₀^{t} denotes the restored block of the base layer of the current frame t, and Dₙ^{t+1} denotes the restored block of the n^{th} enhanced layer of the next frame t+1.

4. The method of claim 1, wherein the prediction signal Pₙ^{t} of the n^{th} enhanced layer of the current frame is defined by:
$${P}_{n}^{t} = \frac{\{ α \times {D}_{n}^{t - 1} + ( 1 - α ) \times {D}_{0}^{t} \} + \{ β \times {D}_{n}^{t + 1} + ( 1 - β ) \times {D}_{0}^{t} \}}{2} + {R}_{n - 1}^{t} ,$$
wherein D₀^{t} denotes the restored block of the base layer of the current frame t, Dₙ^{t-1} denotes the restored block of the n^{th} enhanced layer of the previous frame t−1, Dₙ^{t+1} denotes the restored block of the n^{th} enhanced layer of the next frame t+1, and Rₙ₋₁^{t} denotes the residual data of the (n−1)^{th} enhanced layer of the current frame t.

5. The method of claim 4, wherein the first weighted average sum and the second weighted average sum have values each adaptively changing from 0 to 1 depending on characteristic information of macro-blocks of the n^{th} enhanced layer of the current frame.

6. The method of claim 5, wherein the characteristic information comprises information about prediction direction of the macro-block, and the first weight and the second weight increase when the prediction direction is bi-directional, while the first weight and the second weight decrease when the prediction direction is uni-directional or in an intra-prediction mode.

7. The method of claim 5, wherein the characteristic information comprises information about a Coded Block Pattern (CBP) value, and, when it is determined from the CBP value that there are a small number of included non-zero transform coefficients, the first weight and the second weight increase in an inter-prediction mode, while the first weight and the second weight decrease in an intra-prediction mode.

8. The method of claim 5, wherein the characteristic information comprises information about a Motion Vector Difference (MVD) value for the macro-block, and the first weight and the second weight increase as the MVD value decreases, while the first weight and the second weight decrease as the MVD value increases.

9. A computer-readable recording medium having recorded with program codes for executing the method of claim 1 in a computer.

10. A method of decoding Fine Granular Scalability (FGS) layers by using weighted average sums, the method comprising:
calculating a first weighted average sum by using a restored block of an n^{th} enhanced layer of a previous frame and a restored block of a base layer of a current frame;
calculating a second weighted average sum by using a restored block of the n^{th} enhanced layer of a next frame and the restored block of the base layer of the current frame;
generating a prediction signal of an n^{th} enhanced layer of the current frame by adding residual data of an (n−1)^{th} enhanced layer of the current frame to a sum of the first weighted average sum and the second weighted average sum; and
generating a restored block of the n^{th} enhanced layer by adding the generated prediction signal of the n^{th} enhanced layer to residual data of the n^{th} enhanced layer.

11. The method of claim 10, wherein the first weighted average sum is obtained by:
α×Dₙ^{t-1}+(1−α)×D₀^{t},
wherein α denotes a predetermined first weight, D₀^{t} denotes the restored block of the base layer of the current frame t, and Dₙ^{t-1} denotes the restored block of the n^{th} enhanced layer of the previous frame t−1.

12. The method of claim 10, wherein the second weighted average sum is obtained by:
β×Dₙ^{t+1}(1−β)×D₀^{t},
wherein β denotes a predetermined second weight, D₀^{t} denotes the restored block of the base layer of the current frame t, and Dₙ^{t+1} denotes the restored block of the n^{th} enhanced layer of the next frame t+1.

13. The method of claim 10, wherein the prediction signal Pₙ^{t} of the n^{th} enhanced layer of the current frame is defined by:
$${P}_{n}^{t} = \frac{\{ α \times {D}_{n}^{t - 1} + ( 1 - α ) \times {D}_{0}^{t} \} + \{ β \times {D}_{n}^{t + 1} + ( 1 - β ) \times {D}_{0}^{t} \}}{2} + {R}_{ n - 1}^{ t} ,$$
wherein D₀^{t} denotes the restored block of the base layer of the current frame t, Dₙ^{t-1} denotes the restored block of the n^{th} enhanced layer of the previous frame t−1, Dₙ^{t+1} denotes the restored block of the n^{th} enhanced layer of the next frame t+1, and Rₙ₋₁^{t} denotes the residual data of the (n−1)^{th} enhanced layer of the current frame t.

14. The method of claim 13, wherein the first weighted average sum and the second weighted average sum have values each adaptively changing from 0 to 1 depending on characteristic information of macro-blocks of the n^{th} enhanced layer of the current frame.

15. The method of claim 14, wherein the characteristic information comprises information about prediction direction of the macro-block, and the first weight and the second weight increase when the prediction direction is bi-directional, while the first weight and the second weight decrease when the prediction direction is uni-directional or in an intra-prediction mode.

16. The method of claim 14, wherein the characteristic information comprises information about a Coded Block Pattern (CBP) value, and, when it is determined from the CBP value that there are a small number of included non-zero transform coefficients, the first weight and the second weight increase in an inter-prediction mode, while the first weight and the second weight decrease in an intra-prediction mode.

17. The method of claim 14, wherein the characteristic information comprises information about a Motion Vector Difference (MVD) value for the macro-block, and the first weight and the second weight increase as the MVD value decreases, while the first weight and the second weight decrease as the MVD value increases.

18. A computer-readable recording medium in which program codes for executing the method of claim 10 in a computer are recorded.

19. An encoder for encoding Fine Granular Scalability (FGS) layers by using weighted average sums, the encoder comprising:
a first weighted average sum calculator which calculates a first weighted average sum by using a restored block of an n^{th} enhanced layer of a previous frame and a restored block of a base layer of a current frame;
a second weighted average sum calculator which calculates a second weighted average sum by using a restored block of an n^{th} enhanced layer of a next frame and the restored block of the base layer of the current frame;
a prediction signal generator which generates a prediction signal of an n^{th} enhanced layer of the current frame by adding residual data of an (n−1)^{th} enhanced layer of the current frame to a sum of the first weighted average sum and the second weighted average sum; and
a residual data generator which generates residual data of the n^{th} enhanced layer by subtracting the generated prediction signal of the n^{th} enhanced layer from a restored block of the n^{th} enhanced layer of the current frame.

20. The encoder of claim 19, wherein the first weighted average sum calculator calculates the first weighted average sum by:
α×Dₙ^{t-1}+(1−α)×D₀^{t},
wherein α denotes a predetermined first weight, D₀ denotes the restored block of the base layer of the current frame t, and Dₙ^{t-1} denotes the restored block of the n^{th} enhanced layer of the previous frame t−1.

21. The encoder of claim 19, wherein the second weighted average sum calculator calculates the second weighted average sum by:
β×Dₙ^{t+1}(1−β)×D₀^{t},
wherein β denotes a predetermined second weight, D₀^{t} denotes the restored block of the base layer of the current frame t, and Dₙ^{t+1} denotes the restored block of the n^{th} enhanced layer of the next frame t+1.

22. The encoder of claim 19, wherein the prediction signal generator generates the prediction signal Pₙ^{t} of the n^{th} enhanced layer of the current frame by:
$${P}_{n}^{t} = \frac{\{ α \times {D}_{n}^{t - 1} + ( 1 - α ) \times {D}_{0}^{t} \} + \{ β \times {D}_{n}^{t + 1} + ( 1 - β ) \times {D}_{0}^{t} \}}{2} + {R}_{ n - 1}^{ t} ,$$
wherein D₀^{t} denotes the restored block of the base layer of the current frame t, Dₙ^{t-1} denotes the restored block of the n^{th} enhanced layer of the previous frame t−1, Dₙ^{t+1} denotes the restored block of the n^{th} enhanced layer of the next frame t+1, and Rₙ₋₁^{t} denotes the residual data of the (n−1)^{th} enhanced layer of the current frame t.

23. The encoder of claim 22, wherein the first weighted average sum and the second weighted average sum have values each adaptively changing from 0 to 1 depending on characteristic information of macro-blocks of the n^{th} enhanced layer of the current frame.

24. The encoder of claim 23, wherein the characteristic information comprises information about prediction direction of the macro-block, and the first weight and the second weight increase when the prediction direction is bi-directional, while the first weight and the second weight decrease when the prediction direction is uni-directional or in an intra-prediction mode.

25. The encoder of claim 23, wherein the characteristic information comprises information about a Coded Block Pattern (CBP) value, and, when it is determined from the CBP value that there are a small number of included non-zero transform coefficients, the first weight and the second weight increase in an inter-prediction mode, while the first weight and the second weight decrease in an intra-prediction mode.

26. The encoder of claim 23, wherein the characteristic information comprises information about a Motion Vector Difference (MVD) value for the macro-block, and the first weight and the second weight increase as the MVD value decreases, while the first weight and the second weight decrease as the MVD value increases.

27. A decoder for decoding Fine Granular Scalability (FGS) layers by using weighted average sums, the decoder comprising:
a first weighted average sum calculator which calculates a first weighted average sum by using a restored block of an n^{th} enhanced layer of a previous frame and a restored block of a base layer of a current frame;
a second weighted average sum calculator which calculates a second weighted average sum by using a restored block of an n^{th} enhanced layer of a next frame and the restored block of the base layer of the current frame;
a prediction signal generator which generates a prediction signal of an n^{th} enhanced layer of the current frame by adding residual data of an (n−1)^{th} enhanced layer of the current frame to a sum of the first weighted average sum and the second weighted average sum; and
an enhanced layer restorer which generates a restored block of the n^{th} enhanced layer by adding the generated prediction signal of the n^{th} enhanced layer to residual data of the n^{th} enhanced layer.

28. The decoder of claim 27, wherein the first weighted average sum calculator calculates the first weighted average sum by:
α×Dₙ^{t-1}+(1−α)×D₀^{t},
wherein α denotes a predetermined first weight, D₀^{t} denotes the restored block of the base layer of the current frame t, and Dₙ^{t-1} denotes the restored block of the n^{th} enhanced layer of the previous frame t−1.

29. The decoder of claim 27, wherein the second weighted average sum calculator calculates the second weighted average sum by:
β×Dₙ^{t+1}(1−β)×D₀^{t},
wherein β denotes a predetermined second weight, D₀^{t} denotes the restored block of the base layer of the current frame t, and Dₙ^{t+1} denotes the restored block of the n^{th} enhanced layer of the next frame t+1.

30. The decoder of claim 27, wherein the prediction signal generator generates the prediction signal Pₙ^{t} of the n^{th} enhanced layer of the current frame by:
$${P}_{n}^{t} = \frac{\{ α \times {D}_{n}^{t - 1} + ( 1 - α ) \times {D}_{0}^{t} \} + \{ β \times {D}_{n}^{t + 1} + ( 1 - β ) \times {D}_{0}^{t} \}}{2} + {R}_{ n - 1}^{ t} ,$$
wherein D₀^{t} denotes the restored block of the base layer of the current frame t, Dₙ^{t-1} denotes the restored block of the n^{th} enhanced layer of the previous frame t−1, Dₙ^{t+1} denotes the restored block of the n^{th} enhanced layer of the previous frame t+1, and Rₙ₋₁^{t} denotes the residual data of the (n−1)^{th} enhanced layer of the current frame t.

31. The decoder of claim 30, wherein the first weighted average sum and the second weighted average sum have values each adaptively changing from 0 to 1 depending on characteristic information of macro-blocks of the n^{th} enhanced layer of the current frame.

32. The decoder of claim 31, wherein the characteristic information comprises information about prediction direction of the macro-block, and the first weight and the second weight increase when the prediction direction is bi-directional, while the first weight and the second weight decrease when the prediction direction is uni-directional or in an intra-prediction mode.

33. The decoder of claim 31, wherein the characteristic information comprises information about a Coded Block Pattern (CBP) value, and, when it is determined from the CBP value that there are a small number of included non-zero transform coefficients, the first weight and the second weight increase in an inter-prediction mode, while the first weight and the second weight decrease in an intra-prediction mode.

34. The decoder of claim 31, wherein the characteristic information comprises information about a Motion Vector Difference (MVD) value for the macro-block, and the first weight and the second weight increase as the MVD value decreases, while the first weight and the second weight decrease as the MVD value increases.
